(19) United States
(12) Patent Application Publication
(10) Pub. No.: US 2026/0247110 A1
(43) Pub. Date: Aug. 20, 2026

(54) MANAGEMENT APPARATUS, WIRELESS MOBILE STATION CONFIGURED FOR COMMUNICATION

(71) Applicant: JVCKENWOOD Corporation, Yokohama-shi (JP)

(72) Inventors: Rikiya KASAHARA, Yokohama-shi (JP); Toshiaki NISHIDA, Yokohama-shi (JP); Go TAMURA, Yokohama-shi (JP); Seiichi TANNO, Yokohama-shi (JP)

(21) Appl. No.: 19/566,263

(22) Filed: Mar. 13, 2026

Related U.S. Application Data
(63) Continuation of application No. PCT/JP2024/026935, filed on Jul. 29, 2024.

(30) Foreign Application Priority Data
Sep. 25, 2023 (JP) 2023-161514

(51) Int. Cl. H04W 4/029; H04W 4/10

(52) U.S. Cl. CPC H04W 4/029; H04W 4/10

(57) ABSTRACT

A monitoring interface estimates an abnormality in a wireless mobile station based on a history of position information received by a communication interface from the wireless mobile station. A first instruction interface causes the communication interface to transmit a first instruction signal that requests the wireless mobile station to transmit a sound signal, when the monitoring interface estimates an abnormality in the wireless mobile station. An analyzer analyzes the response signal in response to the first instruction signal. A second instruction interface causes the communication interface to transmit a second instruction signal for requesting a change in an operation of the wireless mobile station when the analyzer determines by analysis that a predetermined condition is met.

### CROSS-REFERENCE TO RELATED APPLICATION

This application is based upon and claims the benefit of priority from the prior Japanese Patent Application No. 2023-161514, filed on Sep. 25, 2023, the entire contents of which is incorporated herein by reference.

### BACKGROUND

### 1. Technical Field

This disclosure relates to management technology and, in particular, to a management apparatus and a wireless mobile station configured for communication.

### 2. Description of the Related Art

In order to prevent a taxi equipped with a wireless mobile station from staying in an area where it is not allowed to pick up passengers, the management apparatus acquires position information from the wireless mobile station and gives an alert instruction to the wireless mobile station that is staying in an inappropriate place (e.g., Patent literature 1).

[Patent literature 1] JP2005-269001

The management apparatus can monitor the behavior of a user possessing the wireless mobile station by acquiring the position information on the wireless mobile station. However, it is difficult to control the operation of the wireless mobile station properly from the management apparatus when it is predicted from the user's behavior that the user is in an emergency situation.

### SUMMARY

A management apparatus according to an embodiment includes: a communication interface that communicates with a wireless mobile station; a monitoring interface that estimates an abnormality in the wireless mobile station based on a history of position information received by the communication interface from the wireless mobile station; a first instruction interface that causes the communication interface to transmit a first instruction signal that requests the wireless mobile station to transmit a sound signal, when the monitoring interface estimates an abnormality in the wireless mobile station; an analyzer that analyzes, when the communication interface receives a response signal including the sound signal in response to the first instruction signal from the wireless mobile station, analyzes the response signal; and a second instruction interface that causes the communication interface to transmit a second instruction signal for requesting a change in an operation of the wireless mobile station when the analyzer determines by analysis that a predetermined condition is met.

Another embodiment relates to a wireless mobile station. The wireless mobile station is a wireless mobile station including: a communication interface that communicates with a management apparatus; a position information acquisition interface that acquires position information on the wireless mobile station and causes the communication interface to transmit the position information; a response interface that causes, when the communication interface receives a first instruction signal for requesting the wireless mobile station to transmit a sound signal from the management apparatus as a result of the management apparatus estimating an abnormality in the wireless mobile station based on a history of the position information, the communication interface to transmit a response signal in response to the first instruction signal; and a change interface that changes, when the communication interface receives a second instruction signal for requesting a change in an operation of the wireless mobile station from the management apparatus based on a result of analysis of the response signal by the management apparatus, the operation of the wireless mobile station in response to the second instruction signal.

Optional combinations of the aforementioned constituting elements, and implementations of the embodiments in the form of methods, apparatuses, systems, recording mediums, and computer programs may also be practiced as modes of the embodiments.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 shows a configuration of a communication system according to an exemplary embodiment;

FIG. 2 shows a configuration of the wireless mobile station of FIG. 1;

FIG. 3 shows a configuration of the management apparatus of FIG. 1;

FIG. 4 shows a sequence chart showing communication steps performed by the communication system of FIG. 1;

FIG. 5 is a flowchart showing communication steps performed by the management apparatus of FIG. 3;

FIG. 6 shows a data structure of a table maintained in the analyzer of FIG. 3; and

FIG. 7 shows a data structure of another table maintained in the analyzer of FIG. 3.

### DETAILED DESCRIPTION

The invention will now be described by reference to the preferred embodiments. This does not intend to limit the scope of the present invention, but to exemplify the invention.

A summary will be given before describing an exemplary embodiment in specific details. The exemplary embodiment relates to a communication system including a wireless mobile station and a management apparatus. The wireless mobile station is possessed by a user and can communicate with other wireless mobile stations. Further, the management apparatus can communicate with the wireless mobile station through a network and receives position information from the wireless mobile station. The management apparatus estimates an abnormality in the wireless mobile station based on a history of position information. Further, the management apparatus estimates the state of the wireless mobile station when an abnormality in the wireless mobile station is estimated and changes the operation of the wireless mobile station according to the estimated state.

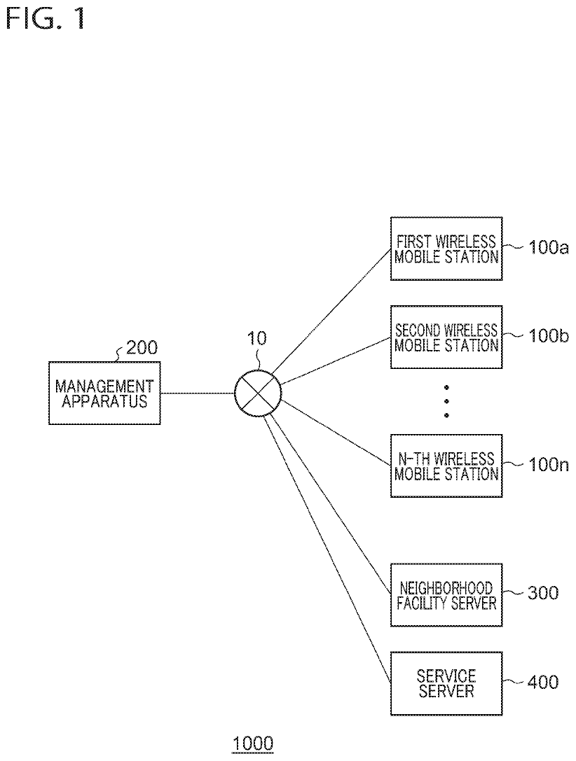

FIG. 1 shows a configuration of a communication system 1000. The communication system 1000 includes a network 10, a first wireless mobile station 100a, a second wireless mobile station 100b, ... an Nth wireless mobile station 100n, which are generically referred to as wireless mobile stations 100, a management apparatus 200, a neighborhood facility server 300, and a service server 400.

The network 10 can perform at least one of wireless communication or wired communication. A known technology may be used for the network 10. The wireless mobile station 100 is a wireless apparatus that has portability and is used by a user. The wireless mobile station 100 can perform sound communication by PTT (Push to Talk). In PTT, the wireless mobile station 100 can transmit a sound signal while the PTT button of the wireless mobile station 100 is being pressed down. Meanwhile, the wireless mobile station 100 can receive a sound signal while the PTT button of the wireless mobile station 100 is not being pressed down. For example, the first wireless mobile station 100a transmits a sound signal to the second wireless mobile station 100b, etc. through the network 10.

The management apparatus 200 is a communication apparatus used by the administrator of the communication system 1000. The management apparatus 200 can communicate with each wireless mobile station 100 through the network 10. The management apparatus 200 estimates the state of the wireless mobile station 100 and changes the operation of the wireless mobile station 100 according to the state. Details of these processes will be described below. The neighborhood facility server 300 is a server used by neighborhood facilities such as the police, fire department, and emergency service. The service server 400 is a server used by a service provider such as a manufacturer and a sales outlet. The management apparatus 200 can communicate with the neighborhood facility server 300 and the service server 400 through the network 10.

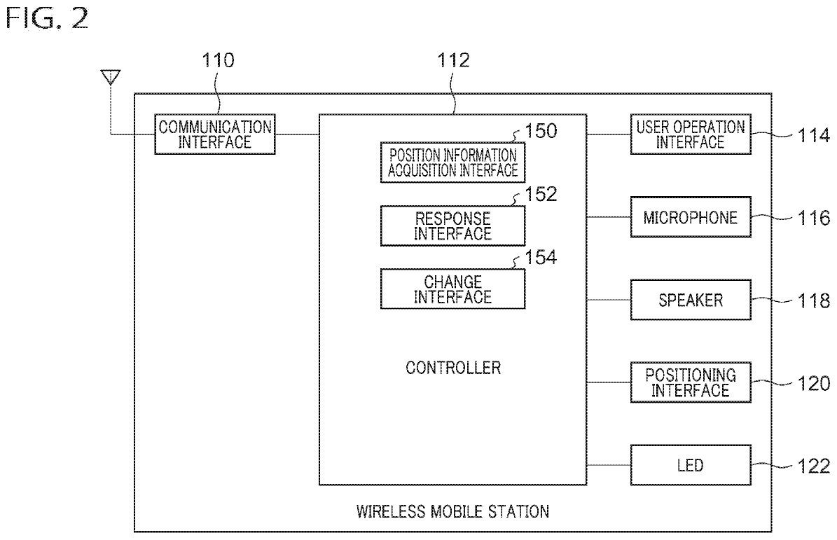

FIG. 2 shows a configuration of the wireless mobile station 100. The wireless mobile station 100 includes a communication interface 110, a controller 112, a user operation interface 114, a microphone 116, a speaker 118, a positioning interface 120, and an LED (Light-Emitting Diode) 122. Further, the controller 112 includes a position information acquisition interface 150, a response interface 152, and a change interface 154.

The communication interface 110 performs wireless communication. Therefore, the communication interface 110 can communicate with other wireless mobile stations 100 and the management apparatus 200 through the network 10. The controller 112 controls the operation of the wireless mobile station 100. Details of the controller 112 will be described later.

The user operation interface 114 is comprised of a button, a touch panel, etc. and receives an input from the user. The button corresponds to the PTT button, and the user operation interface 114 receives an instruction for PTT transmission in response to the PTT button being pressed down. On the other hand, the user operation interface 114 receives an end of transmission by PTT in response to the PTT button being released. The user operation interface 114 outputs the received input to the controller 112. Further, the user operation interface 114 may be other than the PTT button.

The microphone 116 acquires sound. The microphone 116 converts the sound into an electrical signal and outputs the sound in the form of the electrical signal (hereinafter also referred to as “sound”) to the controller 112. For example, the microphone 116 acquires the sound from the user while the PTT button is being pressed down. Further, the microphone 116 may be controlled by the controller 112 to acquire the sound. The speaker 118 outputs the sound played back by the controller 112. The speaker 118 may be controlled by the controller 112 to output a ringing tone.

The positioning interface 120 is compatible with GNSS (Global Navigation Satellite System), receives a signal from a GNSS satellite, and measures the position of the wireless mobile station 100 based on the received signal. The information on the measured position (hereinafter referred to as “position information”) is indicated by, for example, latitude, longitude, altitude, etc. The positioning interface 120 outputs the position information to the controller 112. The LED 122 is controlled by the controller 112 to emit light.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

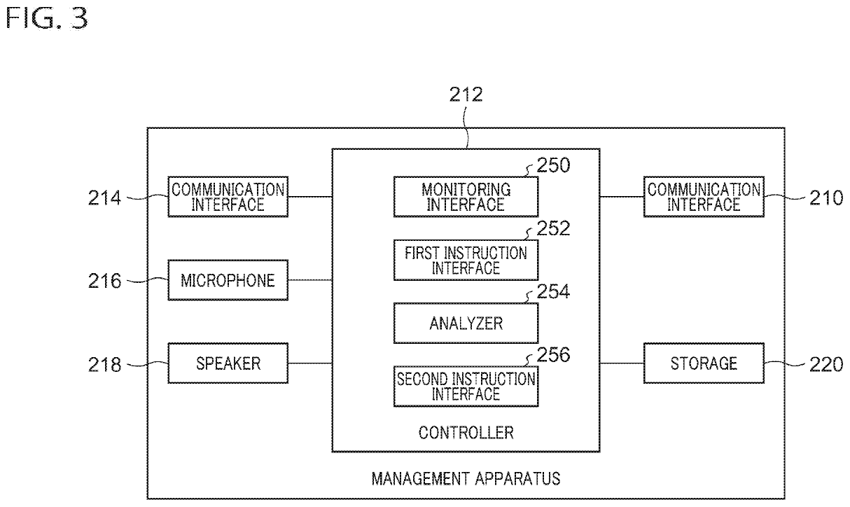

FIG. 3 shows a configuration of the management apparatus 200. The management apparatus 200 includes a communication interface 210, a controller 212, a user operation interface 214, a microphone 216, a speaker 218, and a storage 220. The controller 212 includes a monitoring interface 250, a first instruction interface 252, an analyzer 254, and a second instruction interface 256.

The communication interface 210 performs wired communication. Therefore, the communication interface 210 can communicate with the wireless mobile station 100, the neighborhood facility server 300, and the service server 400 through the network 10. The controller 212 controls the operation of the management apparatus 200. Details of the controller 212 will be described later.

The user operation interface 214 is comprised of a button, a touch panel, a keyboard, etc. and is configured to receive an input from the administrator. The user operation interface 214 outputs a received input to the controller 212. The microphone 216 acquires sound. The microphone 216 converts the sound into an electrical signal and outputs the sound in the form of the electrical signal (hereinafter also referred to as “sound”) to the controller 212. The speaker 218 outputs the sound played back by the controller 212. The storage 220 stores data used in the controller 212.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

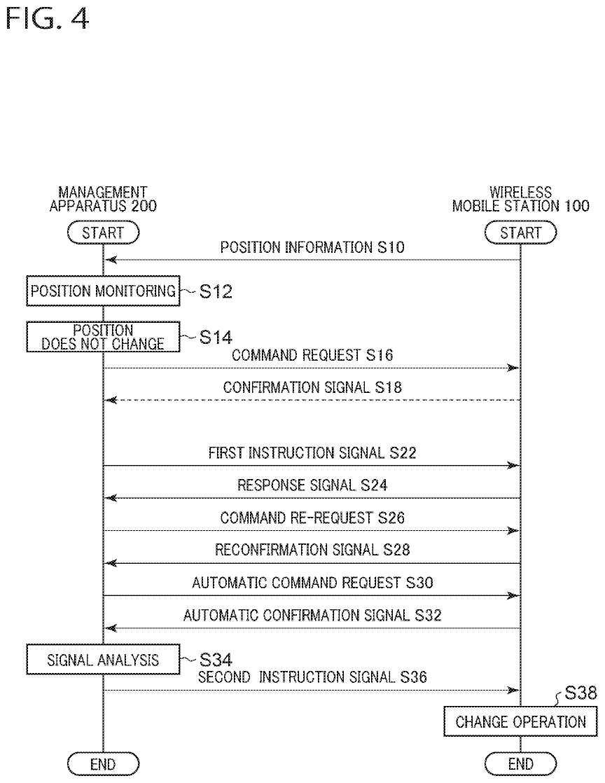

FIG. 4 shows a sequence chart showing communication steps performed by the communication system 1000. The chart shows steps performed by the management apparatus 200 to modify the operation of the wireless mobile station 100 according to the state of the wireless mobile station 100 or the user of the wireless mobile station 100 after the occurrence of an abnormality is estimated by the wireless mobile station 100 or the user of the wireless mobile station 100. In the following, “an abnormality in the wireless mobile station 100 or the user of the wireless mobile station 100” is indicated as “an abnormality in the wireless mobile station 100”, and “the state of the wireless mobile station 100 or the user of the wireless mobile station 100” is indicated as “the state of the wireless mobile station 100”.

The wireless mobile station 100 periodically transmits the position information on the wireless mobile station 100 to the management apparatus 200 (S10). The management apparatus 200 monitors the position of the wireless mobile station 100 based on the received position information (S12). When the position information on the wireless mobile station 100 does not change over a predetermined period of time (S14), the management apparatus 200 estimates the occurrence of an abnormality in the wireless mobile station 100. The management apparatus 200 transmits a command request for confirming the presence of the wireless mobile station 100 (command request signal) to the wireless mobile station 100 (S16).

When the wireless mobile station 100 receives the command request, the wireless mobile station 100 notifies the user of the receipt of the command request. When the user performs a use operation in the wireless mobile station 100, the wireless mobile station 100 transmits a confirmation signal in response to the command request to the management apparatus 200 (S18). It is assumed here that a confirmation signal is not transmitted from the wireless mobile station 100 to the management apparatus 200.

When the management apparatus 200 does not receive a confirmation signal in response to a command request after a predetermined period of time, the management apparatus 200 transmits, to the wireless mobile station 100, a first instruction signal to instruct the wireless mobile station 100 to transmit a sound signal (S22). When the wireless mobile station 100 receives the first instruction signal, the wireless mobile station 100 acquires sound and transmits a response signal including the sound (sound signal) to the management apparatus 200 (S24). The management apparatus 200 also transmits, to the wireless mobile station 100, a command re-request (command re-request signal) to confirm the presence of the wireless mobile station 100 (S26). A command re-request corresponds to a command request transmitted after the second and the subsequent times. The wireless mobile station 100 notifies the user of the receipt of the command re-request when the wireless mobile station 100 receives the command re-request. When the user performs a user operation in the wireless mobile station 100, the wireless mobile station 100 transmits, to the management apparatus 200, a reconfirmation signal in response to the command re-request (S28). When the user does not perform a user operation in the wireless mobile station 100, the wireless mobile station 100 does not transmit a reconfirmation signal to the management apparatus 200. Command re-requests may be transmitted multiple times.

Further, the management apparatus 200 transmits, to the wireless mobile station 100, an automatic command request to confirm the presence of the wireless mobile station 100 (S30). An automatic command request is a command request that does not require a user operation in the wireless mobile station 100. When the wireless mobile station 100 receives an automatic command request, the wireless mobile station 100 transmits, the management apparatus 200, an automatic confirmation signal to in response to the automatic command request (S32). Automatic command requests may be transmitted multiple times.

The management apparatus 200 estimates the state of the wireless mobile station 100 by performing signal analysis (S34) on the response signal, the reconfirmation signal, and the automatic confirmation signal. The management apparatus 200 determines to change in the operation of the wireless mobile station 100 according to the estimated state of the wireless mobile station 100. The management apparatus 200 transmits, to the wireless mobile station 100, a second instruction signal to request a change in the operation of the wireless mobile station 100 (S36). The wireless mobile station 100 changes, when it receives the second instruction signal, its operation in response to the second instruction signal (S38).

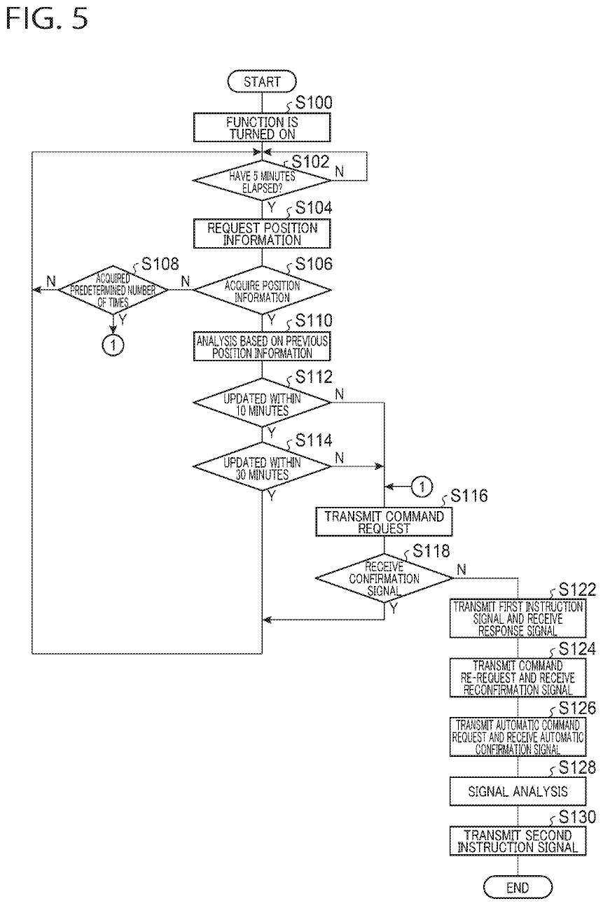

Details of the above process will be described below by using FIGS. 2, 3, and 5. FIG. 5 is a flowchart showing communication steps performed by the management apparatus 200. The function in the management apparatus 200 to acquire information on the wireless mobile station 100 is turned on (S100). The management apparatus 200 stands by before an elapse of 5 minutes (N in S102). When 5 minutes have elapsed, (Y in S102), the communication interface 210 of the management apparatus 200 (FIG. 3) transmits a signal (hereinafter referred to as “position information request signal”) for requesting position information to the wireless mobile station 100 (S104).

The communication interface 110 of the wireless mobile station 100 (FIG. 2) receives the position information request signal. The position information acquisition interface 150 acquires the position information on the wireless mobile station 100 from the positioning interface 120 and causes the communication interface 110 to transmit the position information.

When the monitoring interface 250 of the management apparatus 200 (FIG. 3) does not acquire position information through the communication interface 210 (N in S106) and has not performed the operation of acquisition a specified number of times (N in S108), the monitoring interface 250 returns to step S102. When the monitoring interface 250 has performed the operation of acquisition the specified number of times (Y in S108), control proceeds to step S116 described below. When the monitoring interface 250 acquires the position information through the communication interface 210 (Y in S106), the monitoring interface 250 performs an analysis based on the position information from the previous operation (S110). In the case the time when the position information is acquired is, for example, within 10 minutes from the time of acquisition of the previous position information (Y in S112), control proceeds to step S114. When the position indicated by the position information has moved from the previous position or when the duration of remaining in the same position is, for example, 30 minutes or shorter (Y in S114), control returns to step S102. This is equivalent to the state of monitoring whether the wireless mobile station 100 transmits position information at intervals smaller than the first predetermined period of time and moves within the second predetermined period of time.

When the position information is not acquired within 10 minutes from the time of previous acquisition of the position information (N of S112), or when the position indicated by the position information remains the same longer than 30 minutes (N in S114), on the other hand, it represents a state in which an abnormality is suspected in the wireless mobile station 100. The monitoring interface 250 then estimates an abnormality in the wireless mobile station 100. The first instruction interface 252 causes the communication interface 210 to transmit a command request when the monitoring interface 250 estimates an abnormality in the wireless mobile station 100 (S116).

The communication interface 110 of the wireless mobile station 100 (FIG. 2) receives the command request. When the response interface 152 acquires a command request, the response interface 152 notifies the user of the receipt of the command request by outputting a ring tone from the speaker 118 or lighting up the LED 122. When the user performs a user operate in the user operation interface 114 in response, the response interface 152 causes the communication interface 110 to transmit a confirmation signal in response to the command request. When the user does not perform a user operation in the user operation interface 114, on the other hand, the response interface 152 does not cause the communication interface 110 to transmit a confirmation signal.

When the communication interface 210 of the management apparatus 200 (FIG. 3) receives the confirmation signal from the wireless mobile station 100 (Y in S118), control returns to step S102. This is equivalent to the reception by the management apparatus 200 of a confirmation signal from the wireless mobile station 100 indicating an absence of emergency. As a result, the first instruction interface 252 does not cause the communication interface 210 to transmit the first instruction signal in response to the command request. When the communication interface 210 does not receive a confirmation signal from the wireless mobile station 100 (N in S118), on the other hand, the first instruction interface 252 causes the communication interface 210 to transmit the first instruction signal (S122). When the communication interface 110 of the wireless mobile station 100 (FIG. 2) receives the first instruction signal, the response interface 152 causes the communication interface 110 to transmit a response signal including the sound acquired from the microphone 116 (sound signal). The communication interface 210 of the management apparatus 200 (FIG. 3) receives the response signal from the wireless mobile station 100 (S122). This is equivalent to the management apparatus 200 controlling the wireless mobile station 100 to transmit a sound signal because the user of the wireless mobile station 100 is likely be in an emergency.

Further, the first instruction interface 252 transmits a command re-request to the communication interface 210 (S124). The communication interface 110 of the wireless mobile station 100 (FIG. 2) receives a command re-request. When the response interface 152 acquires the command re-request, the response interface 152 notifies the user of the receipt of the command re-request by outputting a ring sound from the speaker 118 or lighting up the LED 122. When the user performs a user operation in the user operation interface 114 in response, the response interface 152 causes the communication interface 110 to transmit a reconfirmation signal in response to the command re-request. When the user does not perform a user operation in the user operation interface 114, on the other hand, the response interface 152 does not cause the communication interface 110 to transmit a reconfirmation signal. The communication interface 210 of the management apparatus 200 (FIG. 3) receives the reconfirmation signal from the wireless mobile station 100 (S124). When a reconfirmation signal is not transmitted, the communication interface 210 does not receive a reconfirmation signal from the wireless mobile station 100. The controller 212 then stores whether a reconfirmation signal is received in the storage 220. As mentioned above, command re-requests may be transmitted multiple times.

Further, the first instruction interface 252 causes the communication interface 210 to transmit an automatic command request (S126). The communication interface 110 of the wireless mobile station 100 (FIG. 2) receives the automatic command request. When the response interface 152 receives the automatic command request, the response interface 152 automatically causes the communication interface 110 to transmit an automatic confirmation signal in response to the automatic command request. As mentioned above, automatic command requests may be transmitted multiple times. The communication interface 210 of the management apparatus 200 (FIG. 3) receives the automatic confirmation signal from the wireless mobile station 100 (S126). When an automatic confirmation signal is not transmitted, the communication interface 210 does not receive an automatic confirmation signal from the wireless mobile station 100. The controller 212 then remembers whether an automatic confirmation signal is received in the storage 220.

The analyzer 254 analyzes the response signal in response to the first instruction signal, the reconfirmation signal in response to the command re-request, and the automatic confirmation signal in response to the automatic command request (S128). First, the analyzer 254 isolates and acquires human speech sound (speech part) and ambient sound (noise part) from the response signal (sound signal). A known technology may be used to isolate the sound signal into a speech signal and an ambient sound signal. The analyzer 254 calculates the level of the response signal, i.e., the sound signal (hereinafter referred to as “received sound volume level”). Further, the analyzer 254 calculates a spectrum signal by subjecting the sound signal to frequency conversion and then acquires the cepstrum from the spectrum signal. The analyzer 254 determines the peak (pitch) of the cepstrum, calculates the average value of the cepstrum, and uses the peak of the cepstrum and the average value of the cepstrum to determine the speech part. The analyzer 254 calculates the level of the speech part (hereinafter referred to as “call sound volume level”). Further, the analyzer 254 excludes the speech part from the sound signal to acquire the noise part. The analyzer 254 calculates the level of the noise part (hereinafter referred to as “ambient sound volume level”).

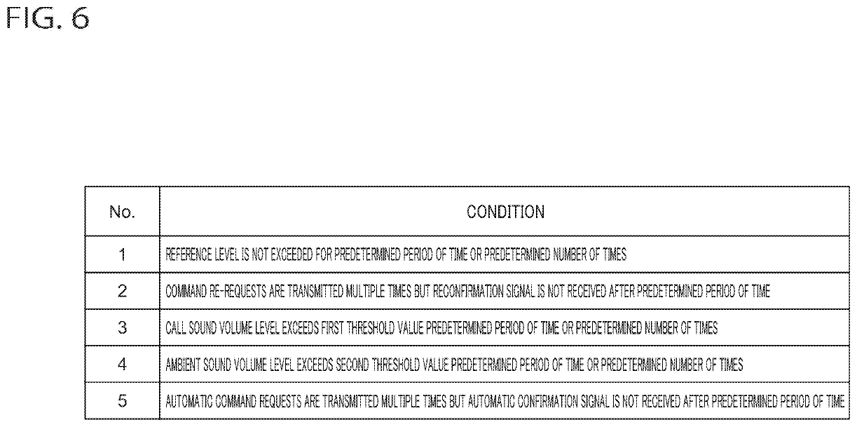

FIG. 6 shows a data structure of a table maintained in the analyzer 254. “No.” indicates a number assigned to a state subject to classification, and “condition” indicates a condition for qualifying as the state. The analyzer 254 determines the state “1” when the received sound volume level does not exceed the reference level for a predetermined period of time or a predetermined number of times. The reference level, the predetermined period of time, and the predetermined number of times are defined in advance. This is presumed to be a state in which it is difficult for the microphone 116 of the wireless mobile station 100 to acquire a sound signal (e.g., the microphone 116 is in the user's pocket or bag). When command re-requests are transmitted multiple times but a reconfirmation signal is not received after the predetermined period of time, the analyzer 254 determines the state “2”. This is presumed to be a state in which the user of the wireless mobile station 100 cannot perform a user operation (e.g., the user is not feeling well).

The analyzer 254 determines the state “3” when the call sound volume level exceeds the first threshold value for a predetermined period of time or a predetermined number of times. In that process, the ambient sound volume level is not used for determination. Further, the first threshold value is predetermined. This is presumed to be a state in which the user of the wireless mobile station 100 is uttering a loud voice (e.g., the user is alerting of a danger). Further, a determination of the state “3” may not rely on the call sound volume level. The meaning of the speech may be extracted from the speech sound by a known speech recognition technology to determine whether the content alerts of a danger. The analyzer 254 determines the state “4” when the ambient sound volume level exceeds the second threshold value for a predetermined period of time or a predetermined number of times. In that process, the call sound volume level is not used for determination. Further, the second threshold value is predetermined. This is presumed to be a state in which an event generating a loud sound is occurring around the user of the wireless mobile station 100 (e.g., an incident such as an accident, disaster, and shooting is occurring). A determination of the state “4” may not rely on the ambient sound volume level. A sound of firing, etc. may be detected by pattern matching with the spectrum signal of the ambient sound to determine whether an incident is occurring. The analyzer 254 determines the state “5” when automatic command requests are transmitted multiple times, but an automatic confirmation signal is not received after a predetermined period of time. This is presumed to be a state in which the wireless mobile station 100 is not operating properly (e.g., the station is in trouble). In the event that multiple conditions are met, the analyzer 254 determines that multiple states are occurring.

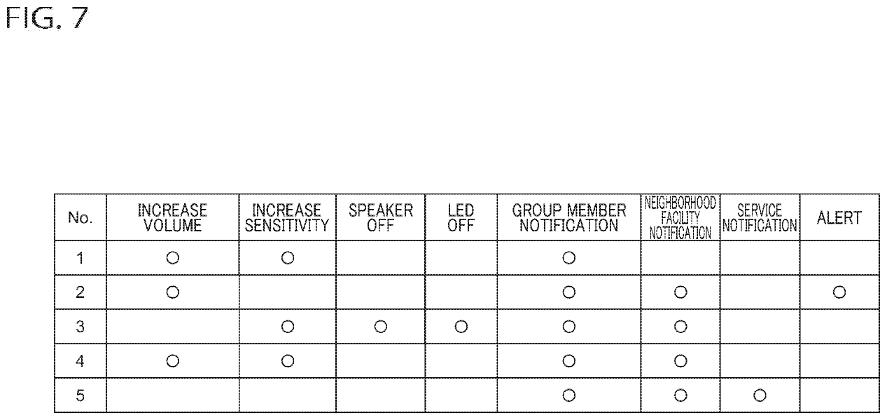

FIG. 7 shows a data structure of another table maintained in the analyzer 254. “No.” in FIG. 7 indicates a number corresponding to the number assigned to the state classified in FIG. 6. “Increase volume” indicates a detail of change in the operation of the wireless mobile station 100, and “○” mark indicates that the change is applicable. In the case of the state “1”, for example, “increase volume” of the speaker 118, “increase sensitivity” of the microphone 116, and “group member notification” are selected. A group member refers to each of the wireless mobile stations 100 included in a pre-registered group. In the case of the state “2”, “increase volume” of the speaker 118, “group member notification”, “neighborhood facility notification”, and output of “alert” from the speaker 118 are selected. “Neighborhood facility notification” indicates that the management apparatus 200 notifies the neighborhood facility server 300.

In the case of the state “3”, “increase sensitivity” of the microphone 116, “speaker off”, “LED off”, “group member notification”, and “neighborhood facility notification” are selected. “Speaker off” indicates turning off the output of the speaker 118, and “LED off” indicates preventing the LED 122 from emitting light. In the case of the state “4”, “increase volume” of the speaker 118, “increase sensitivity” of the microphone 116, “group member notification”, and “neighborhood facility notification” are selected. In the case of the state “5”, “group member notification”, “neighborhood facility notification”, and “service notification” are selected. “Service notification” indicates that the management apparatus 200 notifies the service server 400. Reference is made back to FIG. 5.

The analyzer 254 determines the state by referring to the table of FIG. 6 based on the received sound volume level, call sound volume level, ambient sound volume level, reconfirmation signal, and automatic confirmation signal and determines the detail of change in the operation of the wireless mobile station 100 by referring to the table of FIG. 7 based on the determined state. When the analyzer 254 determines that multiple conditions are met in FIG. 6, the detail of change of FIG. 7 associated with each state is adopted.

The second instruction interface 256 generates a second instruction signal to request a change in the operation of the wireless mobile station 100 based on the detail of change determined by the analyzer 254 and causes the communication interface 210 to transmit the second instruction signal to the wireless mobile station 100 (S130). In the case of the state “1”, the second instruction interface 256 generates the second instruction signal indicating “increase volume” and “increase sensitivity”. Further, the second instruction interface 256 manages identification information on multiple wireless mobile stations 100 included in the group in advance and causes the communication interface 210 to transmit a notification for each of the multiple wireless mobile stations 100. In the case of the state “2”, the second instruction interface 256 generates the second instruction signal indicating “alert”. Further, the second instruction interface 256 causes the communication interface 210 to transmit a notification for the neighborhood facility server 300. The neighborhood facility server 300 is, for example, a server managed by an organization such as the police, fire department, and emergency service and requests the organization to go to the position indicated by the position information on the wireless mobile station 100 for a check.

In the case of the state “3”, the second instruction interface 256 generates the second indication signal indicating “increase sensitivity”, “speaker off”, and “LED off”. Further, the second instruction interface 256 causes the communication interface 210 to transmit a notification for each of the multiple wireless mobile stations 100 and a notification for the neighborhood facility server 300. In the case of the state “4”, the second instruction interface 256 generates the second instruction signal indicating “increase volume” and “increase sensitivity”. Further, the second instruction interface 256 causes the communication interface 210 to transmit a notification for each of the multiple wireless mobile stations 100 and a notification for the neighborhood facility server 300. In the case of the state “5”, the second instruction interface 256 causes the communication interface 210 to transmit s a notification for each of the multiple wireless mobile stations 100, a notification for the neighborhood facility server 300, and a notification for the service server 400. The service server 400 is, for example, a server managed by the repair service department of the wireless mobile station 100 and requests the department to go to the position indicated by the position information on the wireless mobile station 100 for a repair.

The communication interface 110 of the wireless mobile station 100 (FIG. 2) receives the second instruction signal. The change interface 154 changes the operation according to the second instruction signal received by the communication interface 110.

According to the exemplary embodiment, the response signal in response to the first instruction signal is analyzed and a change in the operation of the wireless mobile station is requested, when an abnormality of the wireless mobile station is estimated. Accordingly, the operation of the wireless mobile station can be controlled from the management apparatus when the user possessing the wireless mobile station is in an emergency situation. Further, a command request is transmitted when an abnormality in the wireless mobile station is estimated to determine whether to transmit the first instruction signal depending on whether a confirmation signal in response to the command request is received. Accordingly, the frequency of transmission of the first instruction signal is reduced. Further, since the frequency of transmission of the first instruction signal is reduced, an increase in processing volume is suppressed. Further, a command re-request and an automatic command request are also transmitted when the first instruction signal is transmitted, and the response signal in response to the first instruction signal, the reconfirmation signal in response to the command re-request, and the automatic confirmation signal in response to the automatic command request are analyzed. Accordingly, the accuracy of analysis is improved.

The present disclosure has been described above based on an exemplary embodiment. In the exemplary embodiment, the sound signal is described, but the exemplary embodiment is not limited to that. An information signal such as a data signal may be processed. The embodiment is intended to be illustrative only and it will be understood by those skilled in the art that various modifications to constituting elements and processes could be developed and that such modifications are also within the scope of the present disclosure.

This disclosure covers features that contribute to realization of “sustainable cities and communities” in SDGs (Sustainable Development Goals) and contribute to the safety and security of public facilities.

What is claimed is:

1. A management apparatus comprising:
a communication interface that communicates with a wireless mobile station;
a monitoring interface that estimates an abnormality in the wireless mobile station based on a history of position information received by the communication interface from the wireless mobile station;
a first instruction interface that causes the communication interface to transmit a first instruction signal that requests the wireless mobile station to transmit a sound signal, when the monitoring interface estimates an abnormality in the wireless mobile station;
an analyzer that analyzes, when the communication interface receives a response signal including the sound signal in response to the first instruction signal from the wireless mobile station analyzes the response signal; and
a second instruction interface that causes the communication interface to transmit a second instruction signal for requesting a change in an operation of the wireless mobile station when the analyzer determines by analysis that a predetermined condition is met.

2. The management apparatus according to claim 1,
wherein the analyzer analyzes whether a sound volume level of a speech sound isolated from the sound signal exceeds a first threshold value or whether a sound volume level of an ambient sound isolated from the sound signal exceeds a second threshold value to determine whether the predetermined condition is met.

3. The management apparatus according to claim 1,
wherein the first instruction interface causes the communication interface to transmit a command request signal before transmitting the first instruction signal, when the monitoring interface estimates an abnormality in the wireless mobile station, and
wherein the first instruction interface causes the communication interface to transmit the first instruction signal when the communication interface does not receive a confirmation signal in response to the command request signal from the wireless mobile station.

4. The management apparatus according to claim 3,
wherein the first instruction interface causes the communication interface to transmit a command re-request signal after causing the communication interface to transmit the first instruction signal, and
wherein the analyzer analyzes, when the communication interface receives the response signal in response to the first instruction signal and a reconfirmation signal in response to the command re-request signal from the wireless mobile station, the response signal and the reconfirmation signal.

5. A wireless mobile station comprising:
a communication interface that communicates with a management apparatus;
a position information acquisition interface that acquires position information on the wireless mobile station and causes the communication interface to transmit the position information;
a response interface that causes, when the communication interface receives a first instruction signal for requesting the wireless mobile station to transmit a sound signal from the management apparatus as a result of the management apparatus estimating an abnormality in the wireless mobile station based on a history of the position information, the communication interface to transmit a response signal in response to the first instruction signal; and
a change interface that changes, when the communication interface receives a second instruction signal for requesting a change in an operation of the wireless mobile station from the management apparatus based on a result of analysis of the response signal by the management apparatus, the operation of the wireless mobile station in response to the second instruction signal.
